(19) United States
(12) Patent Application Publication
(10) Pub. No.: US 2019/0021405 A1
(43) Pub. Date: Jan. 24, 2019

(54) ANTIPERSPIRANT BRA WITH INNER LAYER OF NATURAL MATERIALS

(71) Applicant: Leena Palav, Sugarland, TX (US)

(72) Inventor: Leena Palav, Sugarland, TX (US)

(73) Assignee: Leena Palav, Sugarland, TX (US)

(21) Appl. No.: 16/139,065

(22) Filed: Sep. 23, 2018

(51) Int. Cl. A41C 3/00; A41C 5/00; B32B 7/12; B32B 7/06; B32B 27/12

(52) U.S. Cl. CPC A41C 3/0042; A41C 3/005; A41C 5/005; B32B 2437/00; B32B 7/06; B32B 27/12; B32B 2262/062; B32B 7/12

(57) ABSTRACT

The present disclosure relates to a molded cup bra having a first bra cup portion and a second bra cup portion adapted to accommodate breasts of a user. The molded cup bra further includes a first fabric layer adapted to absorb perspiration that is at least adjacent to a skin surface of the user when the molded cup bra is worn, and a second fabric layer provided on inner side of said molded cup bra adapted to reprieve the skin surface of the user from the impact of synthetic materials touching the skin.

### FIELD OF DISCLOSURE

The present disclosure relates to undergarments, in particular it relates to an antiperspirant bra with inner layer of natural materials.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Many garments such as, but not limited to, intimate apparel garments including brassieres, camisoles, bathing suits, pantyhose, leotards, and others are known. Many garments include one or more support and/or shaping regions (“support regions”). For example, brassieres typically include a pair of breast cups for supporting and/or shaping the breasts of the wearer. Some prior art breast cups included a molded foam member that is sewn or otherwise secured to the brassiere in the area of the breast cups.

Sweat evaporation from a person's skin is an important cooling mechanism during exertion. Oftentimes however, athletic apparel fails to effectively move sweat away from the person's skin which impairs the body's cooling mechanism and results in uncomfortable, sweat-saturated garments next to the person's skin. Many women have a tendency to perspire around their bra line, especially when under stress, at work, or when performing physical activity. Excessive unwanted perspiration can result in embarrassing odors, sweat stains, or eventually discoloration of the surrounding clothes. Excessive perspiration can also lead to the need to constantly wash the affected bras, which increases the amount of wear and tear on those bras and thus requires that they be replaced more often. It can be expensive to have to constantly replace worn down bras, especially for women with a unique bra size who must specially order bras to fit their specific measurements.

One problem of particular note for females is the lack of a sport bra with a flexible, molded cup that effectively moves sweat away from the female's body. Sport bras are typically composed of some type of elasticized fabric; the fabric is elasticized in an attempt to provide some degree of support. The elasticized fabric may have moisture management characteristics, but the lack of a molded cup has its disadvantages. For example, unmolded bras provide less support than bras with molded cups. Further, unmolded bras generally have less modesty coverage than bras with molded cups. When molded cups are used in sport bras, the material used for the cups commonly lacks moisture-transporting properties, which means that sweat is not effectively moved away from the skin of the person wearing the sport bra.

Some inventions provide a single, elongated pad designed to be placed between the bra and the individual's breasts. This type of pad is often very uncomfortable, however, and can be difficult to properly place. Other types of perspiration-absorbent pads use straps or adhesives to keep the pad secured in position, but these can be uncomfortable to wear or, in the case of adhesives, leave a residue on the user's skin. Finally, antiperspirants are also available, but they are not one hundred percent effective compared to pads, which wick all of the perspiration that their volume can hold away from the body.

Accordingly, there is a continuing need for garments that overcome, alleviate, and/or mitigate one or more of the above deleterious effects of the prior art. The present invention addresses all of the issues inherent to the prior devices designed to combat perspiration around the bra line, while also providing additional features.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

Brassieres (hereinafter “bra”) are items of clothing that to many wearers are quite personal items. Their selection for purchase is primarily influenced by factors such as the comfort and support the bra provides the wearer. However many models of bras come in varying sizes to accommodate a range of such factors. Other factors that may influence the purchase of a bra are the aesthetic shape of the bra, the purpose for which it may be worn, and the bra color. The way a bra feels may also influence the purchase of a bra. Bra's come in many different materials. Lace, spandex, polyester is all materials that may be used in the construction of a bra. These materials all present a different tactile feel to the bra. Such is a superficial contact characteristic. It may be desirable for a bra to have other characteristics that can be felt, that are not superficial, in order to provide a user with a product that offers different or further factors that may appeal to them.

The present disclosure relates to undergarments, in particular it relates to an antiperspirant bra with inner layer of natural materials.

An aspect of the present disclosure relates to a molded cup bra having a first bra cup portion and a second bra cup portion adapted to accommodate breasts of a user. The molded cup bra further includes a first fabric layer adapted to absorb perspiration that is at least adjacent to a skin surface of the user when the molded cup bra is worn, and a second fabric layer provided on inner side of said molded cup bra adapted to reprieve the skin surface of the user from the impact of synthetic materials touching the skin.

In an aspect, the first layer includes a plurality of layers. In another aspect, the plurality of layers comprising: a first layer comprising a porous hydrophobic substance, a second layer comprising an absorptive textile material, a third layer comprising an absorptive gel, and a fourth layer comprising a superabsorbent polymer.

In an aspect, the first fabric layer comprised of a cotton material.

In an aspect, the first fabric layer is secured with the molded cup bra by an adhesive, the adhesive adapted to removably attach the first fabric layer to the molded cup bra.

In an aspect, the first fabric layer is secured with the molded cup bra by a stitching mechanism.

In an aspect, the first fabric layer is made of a stretchable elasticized fabric so that the first fabric layer can be stretched over the breasts of the user.

In an aspect, the first fabric layer or the second fabric layer configured to release of one or more chemical agents. In another aspect, the one or more chemical agents are selected from deodorants, perfumes, antiperspirants, and medications.

In an aspect, the first fabric layer or the second fabric layer configured to release of one or more additives, the additives are selected from a skin moisturizer, an antiperspirant, an antibiotic, a scent-release chemical, and/or a topical analgesic.

In an aspect, the first and second fabric layer provides different feel that will at least provide the public with a useful choice.

In an aspect, the first and second fabric layer relates to wicking, antibacterial/bacteriostatic/antifungal, (hereinafter referred to as antibacterial/antifungal, antibacterial/bacteriostatic, or antibacterial/bacteriostatic/antifungal), and low friction apparel and methods for producing same, such as clothing, fabrics and the like. More particularly, the first and second fabric layer relates to wicking, antibacterial/antifungal, low friction apparel which incorporates fabrics or chemicals which wick, have antibacterial/antifungal properties and low coefficient of friction either overall or in specific areas of the apparel that will minimize the development of irritation of a person's skin and related bacterial and fungal infections.

Other features of embodiments of the present disclosure will be apparent from accompanying drawings and from detailed description that follows.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates a proposed molded cup bra with a first fabric layer and a second fabric layer, in accordance with an exemplary embodiment of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Reference is made herein to the attached drawings. Like reference numerals are used throughout the drawings to depict like or similar elements of the disposable bra liner. For the purposes of presenting a brief and clear description of the present invention, the preferred embodiment will be discussed as used for placing the present liner within a bra to absorb perspiration and provide additional vertical support to the individual's breasts. The figures are intended for representative purposes only and should not be considered to be limiting in any respect.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Reference will now be made in detail to the preferred embodiments of the invention illustrated in the accompanying drawings. Wherever possible, the same or like reference numbers will be used throughout the drawings to refer to the same or like features. It should be noted that the drawings are in simplified form and are not drawn to precise scale. In reference to the disclosure herein, for purposes of convenience and clarity only, directional terms such as top, bottom, above, below and diagonal, are used with respect to the accompanying drawings. Such directional terms used in conjunction with the following description of the drawings should not be construed to limit the scope of the invention in any manner not explicitly set forth. Additionally, the term “a,” as used in the specification, means “at least one.” The terminology includes the words above specifically mentioned, derivatives thereof, and words of similar import.

Skin when rubbing against another surface of skin causes irritation, breaks down and becomes irritated. Perspiration is usually also present in areas where skin rubs together. Intertrigo, or a rash in body folds, develops. Affected skin is reddened and uncomfortable. Body folds are prone to inflammatory rashes because the skin has a relatively high temperature, moisture from insensible water loss and sweat cannot evaporate, and friction from movement of adjacent skin results in chafing. Bacteria, fungus and yeasts, which are normally resident on the skin, multiply in such environments and may result in further damage to the skin.

It can appear anywhere two skin surfaces lie next to each other and rub together, but most often occur in the skin folds of the groin, the inner thigh area, underarms, between the ribs, and under and between the breasts. This condition is most common in warm climates and during the summer months. Intertrigo will appear as a reddish color rash that might be sore or itchy. It normally progresses gradually, starting as a mild chafing, then slowly, with continued exposure to moisture and friction, develops into a persistent itchy rash. Sometimes a secondary bacterial or fungal infection may occur, causing the formation of pustules and weeping and oozing of the skin, as well as severe itching and pain. Severe Intertrigo on the groin or thighs can limit or affect mobility. Intertrigo primarily affects overweight people who perspire heavily and people with diabetes. It can also occur in any individual where fat distribution causes two surfaces of the skin to rub together. Persons who suffer from urinary incontinence are at increased risk of developing Intertrigo in the groin area. Once a person develops Intertrigo it is usually chronic and reoccurring.

Previous patents have addressed part of the problem, that is, the addition of fibers with low co-efficient of friction into apparel to reduce friction. Conversely, existed patents only address wicking properties, especially garments designed for incontinence problems. In doing so, they only addressed part of the problem with skin irritation. None have addressed both factors, that is, moisture and friction as being the causative agents for creating Intertrigo. Prior art has failed to combine wicking and low friction materials to solve the problem and with obesity becoming an epidemic world wide a solution to this problem is important.

Accordingly, there is a continuing need for garments that overcome, alleviate, and/or mitigate one or more of the above deleterious effects of the prior art. The present invention addresses all of the issues inherent to the prior devices designed to combat perspiration around the bra line, while also providing additional features.

The present disclosure relates to undergarments, in particular it relates to an antiperspirant bra with inner layer of natural materials.

The terms “inner” or “inside” in this specification is used to mean the layer or side of the bra that touches the wearer's skin.

The term “lining” in this specification is used to mean a layer attached to the inner side of the bra or bra component. A “brushed” bra component such as “brushed cotton underwire” or brushed cotton strap” is not a claim in this specification. A “lining” is a distinct natural cloth layer attached as an additional layer over the bra component. The lining also covers the synthetic component of the bra body completely, not partially.

The term “natural material” in this specification means a material made from natural fibers such as cotton, bamboo, silk or wool or any other natural material or natural material blend, preferably of a soft feel to the touch. The material may or may not be certified organic.

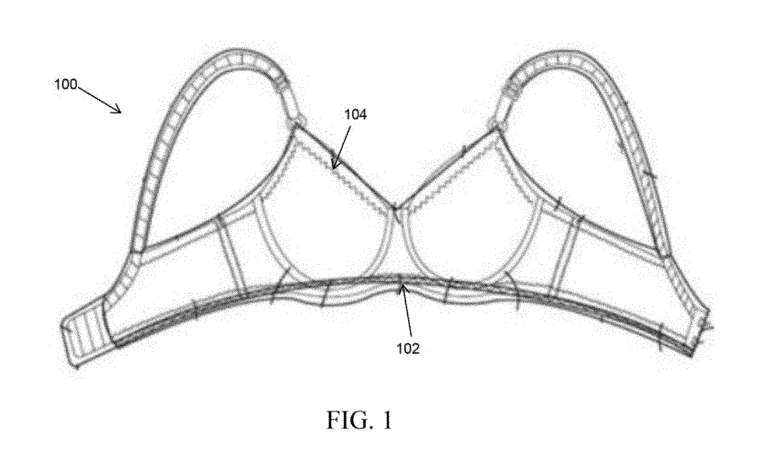

The term “bra body” is used to indicate all bra components other than the shoulder straps and hooks/fasteners, laces or decorative accessories placed on the outside/front of the bra. Refer to FIG. 1 for illustration of terms used in this specification.

Typical bra components that comprise the bra body and that may be made of synthetic material include the cups, the bands, the power strips or meshes, hook or fastener straps, the support stays, the wings, the underwire, if they are present and any other component that may not be listed here.

This invention is unique in the scope and detail of the bra components that are lined, the type of material that is used for lining and in the finished or permanent nature of attachment of the lining(s). There could be bra designs that have some lining but they are limited to a few components—say the cups—and/or they may not be made of natural material. This invention creates a bra with inner lining(s) in natural materials over all of the synthetic bra components that touch the skin across the entire bra body. With this unique design, women users can derive a comfortable feeling and reduce the touch of synthetic materials.

In this invention, there could be many methods to attach the lining(s); examples are stitching, attaching with glue or fasteners, hot press or any other method of attaching a natural material fabric.

In this invention, the lining(s) could be firstly attached to the bra component and then the component attached to the bra body or the lining(s) could be attached to the entire bra body once it is finished. If the rest of bra material is already a natural material, the same fabric could be simply be folded over to create an inner lining of this invention, where it is folded over an elastic band. Or it could be folded over, where, in this invention, it is folded over a support stay.

As shown in FIG. 1, a bra 100 comprises a first fabric layer 102 of anti perspiration material cloth and a second fabric layer 104 of natural material cloth attached to the inner side of the bra.

The layers 102 and 14 can be attached to the inner side of a strap, and/or the inner side of a central power strip, and/or the inner side of elastic bands and/or on a support that is inserted in the bra.

An aspect of the present disclosure relates to a molded cup bra having a first bra cup portion and a second bra cup portion adapted to accommodate breasts of a user. The molded cup bra further includes a first fabric layer adapted to absorb perspiration that is at least adjacent to a skin surface of the user when the molded cup bra is worn, and a second fabric layer provided on inner side of said molded cup bra adapted to reprieve the skin surface of the user from the impact of synthetic materials touching the skin.

In an aspect, the first layer includes a plurality of layers. In an exemplary embodiment, the first layer comprises a porous, hydrophobic substance such as polyester or polypropylene. This is the layer that comes in contact with the user's skin and therefore must be simultaneously comfortable and allow moisture to pass through it and enter the deeper layers of the absorptive portion. The second layer comprises a textile or textile-like material with strong absorptive capabilities, such as air-laid paper. This is the first layer of the absorptive portion that is designed to absorb moisture. This layer is also provided to impart additional volume to the bra cup liner, thereby increasing the present invention ability to provide vertical support to users. The third and fourth layers of the absorptive portion comprise an ultra-absorbent gel and a superabsorbent polymer, respectively. The primary purpose of these layers is solely to absorb moisture wicked away from the user's skin.

In an aspect, the first fabric layer comprised of a cotton material.

In an aspect, the first fabric layer is secured with the molded cup bra by an adhesive, the adhesive adapted to removably attach the first fabric layer to the molded cup bra. The adhesive is composed of any material known in the prior capable of removably, but securely, affixing the present invention within the bra. The adhesive may be a layer of adhesive or a film placed along the backside of the first layer, and will preferably not leave a residue behind on the bra once it is removed. The adhesive allows the present invention to self-secure within bra cups so it is easy to install and use.

In an aspect, the first fabric layer is secured with the molded cup bra by a stitching mechanism.

In an aspect, the first fabric layer is made of a stretchable elasticized fabric so that the first fabric layer can be stretched over the breasts of the user.

In an aspect, the first fabric layer or the second fabric layer configured to release of one or more chemical agents. In another aspect, the one or more chemical agents are selected from deodorants, perfumes, antiperspirants, and medications.

In an aspect, the first fabric layer or the second fabric layer configured to release of one or more additives, the additives are selected from a skin moisturizer, an antiperspirant, an antibiotic, a scent-release chemical, and/or a topical analgesic.

In an aspect, the first and second fabric layer provides different feel that will at least provide the public with a useful choice.

In an aspect, the first and second fabric layer relates to wicking, antibacterial/bacteriostatic/antifungal, (hereinafter referred to as antibacterial/antifungal, antibacterial/bacteriostatic, or antibacterial/bacteriostatic/antifungal), and low friction apparel and methods for producing same, such as clothing, fabrics and the like. More particularly, the first and second fabric layer relates to wicking, antibacterial/antifungal, low friction apparel which incorporates fabrics or chemicals which wick, have antibacterial/antifungal properties and low coefficient of friction either overall or in specific areas of the apparel that will minimize the development of irritation of a person's skin and related bacterial and fungal infections.

In an exemplary embodiment, the bra can be fully lined with the first and second fabric layer. It is unique from the other bra designs in the scope and detail of the bra components that are lined, as well as the type of material used in the lining. With this unique design, women users can derive a comfortable feeling and reduce the synthetic materials touching the skin.

In an exemplary embodiment, the bra in this invention comprises of a standard bra of two cups, an under bust support and fastening, each of which can be any style, with a full attached lining(s) on all of the inside of the bra body, with the lining(s) made of natural materials to cover the synthetic material bra components that might be used in the bra.

The bra in this invention provides the touch of natural material to the skin of the wearer. It seeks to reduce the irritation caused by the touch of synthetic materials for some wearers, to give more comfort, breathability or sweat absorption, while maintaining aesthetic and support features of the bra.

The natural material used for the linings and the rest of the bra body touching the skin can be cotton, modal, bamboo, silk or a similar material. These materials may be certified organic or not. The lining(s) is permanently attached to the bra and covers the bra components of the bra body that are made of synthetic materials.

Typical bra components that comprise the bra body and that may be made of synthetic materials, and are all lined with the natural material in this invention, include the cups, the bands, the power strips or mesh, hook or fastener straps, the support bands, the underwire, the wings, if they are present, and other components not listed here that comprise a bra body and that may be synthetic in material.

Any bra style can be lined. The foregoing description of the invention has been presented for purposes of illustration and description and is not intended to be exhaustive or to limit the invention to the precise form disclosed, and obviously many modifications and variations are possible, depending on the style of the bra. The bra styles in this invention can include with and without underwire, with and without padded or molded cups, seamed and seamless cups, push up and non push cups, with and without straps, with and without fastening, with and without elastic bands, with and without support stays, with and without power strips and with any style of coverage and similar variations. The bra in this invention can have an intended use of regular wear or maternity wear or sportswear or any other wear. This invention seeks to line all bra body components, used in any style that may be synthetic in nature.

In an exemplary embodiment, the first fabric and the second fabric layer according to the present invention covers all of the inner side of the bra in front, side and back which is touching the body, with a natural material such as cotton, modal, bamboo, silk. These may be certified organic or not. Bra components that are lined with the natural material include the cups, the bands, the wings, the center, hook strap, the support bands, the power mesh and similar components. A basic bra drawing is included to illustrate component names.

The intent is to give the wearer the feeling of wearing natural material next to skin, to prevent unnecessary chaffing, rubbing and allergic reactions to synthetic materials and to give more comfort and breathability.

Any bra design can be lined. Examples include with and without underwire, with and without padding or molding, with an intended use of regular wear or maternity wear or sportswear or any other wear.

While the invention has been illustrated and described as embodied in a combine harvester, it is not intended to be limited to the details shown, since various modifications and structural changes may be made without departing in any way from the scope of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Identical or corresponding components are provided with the same reference numerals in the various FIGURES of the drawing and the various embodiments. If individual components are omitted in the FIGURES of the drawing for purposes of illustration or representation, the components in question in the other FIGURES are to be supplemented accordingly. It is apparent to those skilled in the art that the features of the individual embodiments are also exchangeable among the embodiments; thus, the features disclosed with respect to one embodiment may also be identically or correspondingly provided in the other embodiments. It is also apparent to those skilled in the art that the features disclosed in the individual embodiments, taken by them in each case, i.e., independently of the other features of the particular embodiment, further embody the invention.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

What is claimed is:

1. A molded cup bra, comprising:
a first bra cup portion and a second bra cup portion adapted to accommodate breasts of a user;
a first fabric layer adapted to absorb perspiration that is at least adjacent to a skin surface of the user when the molded cup bra is worn; and
a second fabric layer provided on inner side of the molded cup bra adapted to reprieve the skin surface of the user from the impact of synthetic materials touching the skin.

2. The molded cup bra of claim 1, wherein the first fabric layer comprising a plurality of layers.

3. The molded cup bra of claim 2, wherein the plurality of layers comprising: a first layer comprising a porous hydrophobic substance, a second layer comprising an absorptive textile material, a third layer comprising an absorptive gel, and a fourth layer comprising a superabsorbent polymer.

4. The molded cup bra of claim 1, wherein the first fabric layer comprised of a cotton material.

5. The molded cup bra of claim 1, wherein the first fabric layer is secured with the molded cup bra by an adhesive, the adhesive adapted to removably attach the first fabric layer to the molded cup bra.

6. The molded cup bra of claim 1, wherein the first fabric layer is secured with the molded cup bra by a stitching mechanism.

7. The molded cup bra of claim 1, wherein the first fabric layer is made of a stretchable elasticized fabric so that the first fabric layer can be stretched over the breasts of the user.

8. The molded cup bra of claim 1, wherein the first fabric layer or the second fabric layer configured to release of one or more chemical agents.

9. The molded cup bra of claim 8, wherein the one or more chemical agents are selected from deodorants, perfumes, antiperspirants, and medications.

10. The molded cup bra of claim 1, wherein the first fabric layer or the second fabric layer configured to release of one or more additives, the additives are selected from a skin moisturizer, an antiperspirant, an antibiotic, a scent-release chemical, and/or a topical analgesic.
